(19) United States
(12) Patent Application Publication
(10) Pub. No.: US 2004/0238888 A1
(43) Pub. Date: Dec. 2, 2004

(54) Thin film transistor substrate and method of manufacturing the same

(76) Inventors: Kyounei Yasuda, Kanagawa (JP); Hiroaki Tanaka, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/856,401

(22) Filed: May 28, 2004

(30) Foreign Application Priority Data
May 30, 2003 (JP) 153751/2003

(51) Int. Cl. G02F 1/1339

(52) U.S. Cl. 257/347

(57) ABSTRACT

Lest gate lead lines 122 which are readily corrodable in atmosphere should be exposed on the cutting surface formed at the time of separating an inner display area, which includes gate and drain terminals, in an eventual TFT substrate 100 from static electricity protection lead lines 4 and static electricity protection elements 19, gate terminal electrodes 115 which is formed from corrosion-resistant ITO are cut apart in the vicinity of the gate and drain terminals 3 and 8.

### BACKGROUND OF THE INVENTION

This application claims benefit of Japanese Patent Application No. 2003-153751 filed on May 30, 2003, the contents of which are incorporated by the reference.

The present invention relates to thin film transistor substrates and methods of manufacturing the same and, more particularly, to terminals of thin film transistor substrates and methods of manufacturing the same.

In a thin film transistor (TFT) substrate of a liquid crystal display device, a static electricity protection lead line is provided on the substrate edges, and to this lead line gate lead lines and drain lead lines (or signal lines) are connected via static electricity protection transistors shown in FIG. 3.

In FIG. 3, a TFT substrate 100 has laterally provided gate lead lines 2 and gate terminals 3. A static electricity protection lead line 4 is formed along the substrate edges. The gate lead lines 2 are led past gate terminals 3 to become gate lead lines 22 and be connected via static electricity protection elements 19 to the static electricity protection lead line 4. The TFT substrate 100 also has drain lead lines 7 provided to extend vertically at right angles to the gate lead lines 2. The drain lead lines 7 are also led past drain terminals 8 to become drain lead lines 27 and be connected via static electricity protection elements 19 to the static electricity protection lead line 4. Thin film transistors 10 are provided at intersections of the gate and drain lead lines 2 and 7. The static electricity protection elements 19 are constituted by transistors of the same structure as the thin film transistors 10.

FIG. 4(a) is an enlarged-scale plan view showing the neighborhood of the gate terminals 3, gate lead lines 22, static electricity protection elements 19 and static electricity protection lead lines 4. The TFT substrate 200 is obtained by cutting apart the eventual one along a cut-apart line I-I as shown in the Figure. (This also is the case with the substrate on the side of the drain terminals 8.) This means that the gate lead lines 22 between the gate terminals 3 and the static electricity protection elements 19 and the drain lead lines 28 between the drain terminals 8 and the static electricity protection elements 19 are cut apart. FIG. 4(b) is a sectional view taken along line II-II shown in FIG. 4(a). More specifically, the Figure is a section of a gate terminal 3, a gate terminal electrode 15, a gate lead line 2, a gate lead line 22 and a thin film transistor 10 in a display area. Likewise, FIG. 5(a) is an enlarged-scale plan view showing the neighborhood of drain terminals 8, drain lead lines 27, static electricity protection elements 19 and static electricity protection lead lines 4. FIG. 5(b) is a sectional view taken along line II-II in FIG. 5a). In FIG. 4(a) (as well as FIG. 5(a)), for the sake of the brevity the thin film transistors 10 excluding the gate terminals 3, the gate terminal electrodes 15, the gate lead lines 2 and the gate lead lines 22 are shown schematically.

The structure in the neighborhood of the gate and drain terminals 3 and 8 will be described with reference to FIGS. 4(a) and 4(b) and FIGS. 5(a) and 5(b).

As the gate lead line material, a single layer of molybdenum is used. In the gate lead line photo resist step, the gate terminals 3 and the static electricity protection lead line 4 are formed together with the gate lead lines 2 on a transparent substrate 1. Then, a gate insulating film 5 is deposited, and a semiconductor layer 6 is formed thereon. A drain lead line (including a drain electrode) 7, a drain terminal 8 and a source electrode 9 are then formed by using a single layer of molybdenum. The individual thin film transistors 10 and static electricity protection elements 19 are formed. At the same time, the gate and drain lead lines 2 and 7 are connected via static electricity protection elements 19 to the static electricity protection lead line 4. Subsequently, gate and drain terminal electrodes 15 and 16 and a polarization film 17 covering these terminal electrodes, are formed together with an inter-layer insulating film 11 including a protective film and pixel electrodes constituted by terminal part contact holes 12 and 13 and ITO. Finally, the gate and drain lead lines 22 and 27 between the static electricity protection lead line 4 and the gate and drain terminals 3 and 8 are cut apart to separate the static electricity protection lead line 4 and the static electricity protection elements 19 along the edges of the eventual TFT substrate 100 from the TFT substrate 200 including the gate and drain terminals 3 and 8.

The structure with gate terminal parts having ITO gate terminal electrodes are shown in, for instance, Literature 1 (Japanese Patent Laid-open Hei 6-95146, see column [0020] and FIG. 4).

However, by cutting apart the gate and drain lead lines 22 and 27 between the static electricity protection lead line 4 and the gate and drain terminals 3 and 8, corrosion of the gate and drain lead lines 22 and 27 readily proceeds due to exposure of the cutting surface of molybdenum which is readily corroded in atmosphere, thus leading the possibility of breakage in long time of use. Other than molybdenum, Al single layer, Mo/Al laminate layer, etc. are readily subject to corrosion in atmosphere. Particularly, in the case of the Mo/Al laminate structure, the corrosion is accelerated by a battery action between different metals.

### SUMMARY OF THE INVENTION

An object of the present invention, therefore, is to provide a thin film transistor substrate and a method of manufacturing the same, which ensure, when the display area is cut apart form the static electricity protection lead lines, the freedom from corrosion of the lead lines from the cutting surface of the display area.

According to an aspect of the present invention, there is provided a thin film transistor substrate comprising a first substrate, gate lead lines provided on the first substrate and having gate terminals formed along the substrate edges, a first insulating film provided on the first substrate such as to cover the gate lead lines, drain lead lines crossing the gate lead lines and having drain terminals formed along the substrate edges, a second insulating film formed on the first insulating film such as to cover the drain lead lines, and gate and drain terminal electrodes covering gate and drain terminal holes, respectively, formed in insulating film on the gate and drain terminals and extending on the outer side of the gate and drain terminals, the gate and drain terminal electrodes being formed by a material having a character of resisting corrosion in atmosphere.

The gate and drain terminal electrodes are formed by cutting apart, in a state that the gate and drain terminal electrodes extend to the outer side of the gate and drain terminals and are connected to an edge lead line formed along the edges of the first substrate, parts of the gate and drain terminal electrodes extending to the outer side of the gate and drain terminals. The material having the character of resisting corrosion in atmosphere is a transparent material. The transparent material is ITO (indium titanium oxide) or IZO (indium zinc oxide). The material having the character of resisting corrosion in atmosphere is a high-melting metal. The high-melting metal is selected from the group consisting of Cr, Ti, Nb, V, W, Ta, Zr or Hf.

According to another aspect of the present invention, there is provided a method of manufacturing a thin film transistor substrate comprising: a gate lead line forming step of forming gate lead lines having gate terminals along the edges of a first substrate; a first insulating film forming step of forming a first insulating film on the first substrate such as to cover the gate lead lines; a drain lead line forming step of forming, on the first insulating film, drain lead lines crossing the gate lead lines and having drain terminals formed along the substrate edges; a second insulating film forming step of forming a second insulating film on the first insulating film such as to cover the drain lead lines; a terminal hole forming step of forming gate and drain terminal holes in insulating film parts on the gate and drain terminals; and a terminal electrode forming step of forming gate and drain terminal electrodes covering the gate and drain terminal holes and extending to the outer side of the gate and drain terminals; the gate and drain terminal electrodes being formed from a material having a character of resisting corrosion in atmosphere.

An edge lead line is formed on the first substrate along the edges thereof in the gate or drain gate lead line forming step, edge lead line holes are formed on insulating film on the edge lead line in the terminal hole forming step, in the terminal electrode forming step the gate and drain terminal electrodes are formed such as to extend to the outer side of the gate and drain terminals and past the edge lead line holes so as to be connected to the edge lead line, and the terminal electrode forming step is followed by a terminal electrode cut-apart step of cutting apart parts of the gate and drain terminal electrodes extending to the outer side of the gate and drain terminals.

The material having the character of resisting corrosion in atmosphere is a transparent material. The transparent material is ITO (indium titanium oxide) or IZO (indium zinc oxide). The material having the character of resisting corrosion in atmosphere is a high-melting metal. The high-melting metal is selected from the group consisting of Cr, Ti, Nb, V, W, Ta, Zr or Hf.

Other objects and features will be clarified from the following description with reference to attached drawings.

### BRIEF DESCRIPTION OF THE DRAWINGS

FIGS. 1(a) and 1(b) are a plan view in the neighborhood of gate terminals in the embodiment of the thin film transistor substrate according to an embodiment of the present invention and a sectional view taken along line II-II in FIG. 1(a);

FIGS. 2(a) and 2(b) are a plan view in the neighborhood of drain terminals in the embodiment of the thin film transistor substrate according to an embodiment of the present invention and a sectional view taken along line II-II in FIGS. 2(a);

FIG. 3 is a partial plan view showing the neighborhood terminals of the thin film transistor substrate;

FIGS. 4(a) and 4(b) are a plan view in the neighborhood of gate terminals of the prior art thin film transistor substrate and a sectional view taken along line II-II in FIG. 4(a); and

FIGS. 5(a) and 5(b) are a plan view in the neighborhood of drain terminals of the prior art thin film transistor substrate and a sectional view taken along line II-II in FIG. 5(a).

### PREFERRED EMBODIMENTS OF THE INVENTION

Preferred embodiments of the present invention will now be described with reference to the drawings.

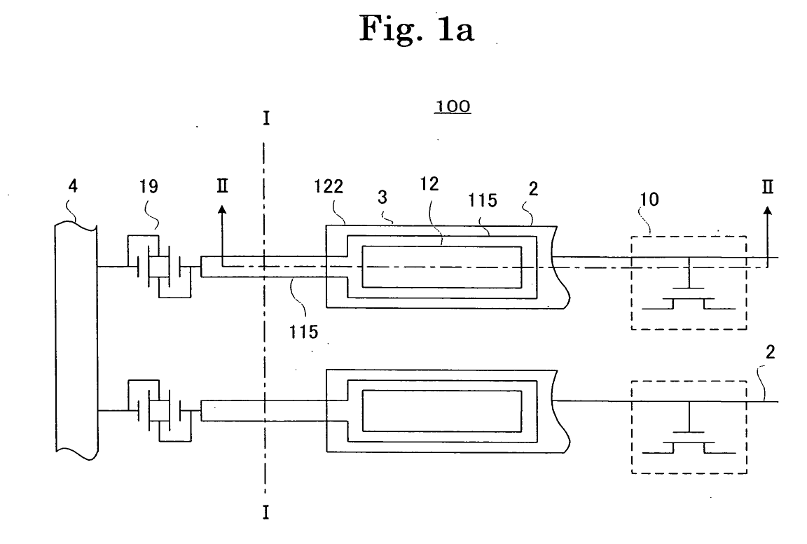

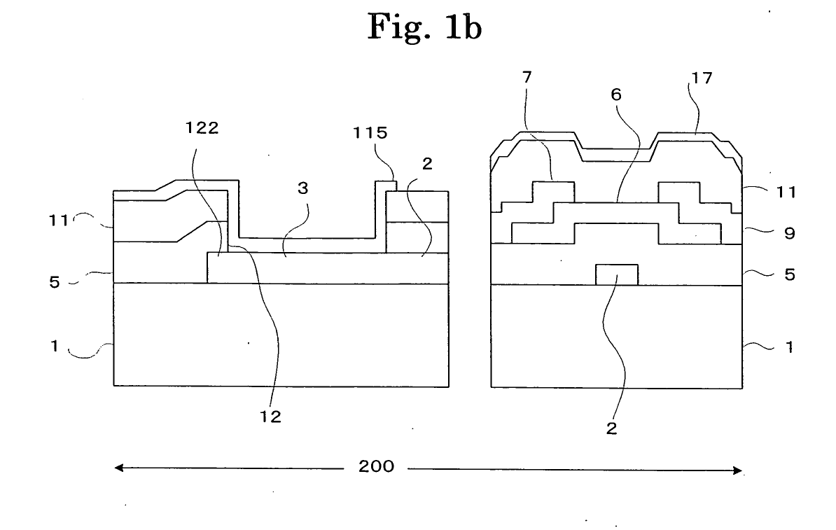

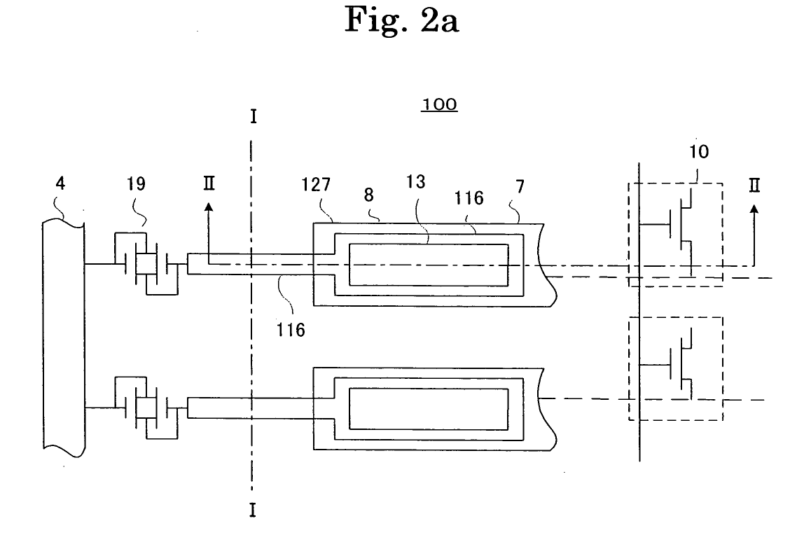

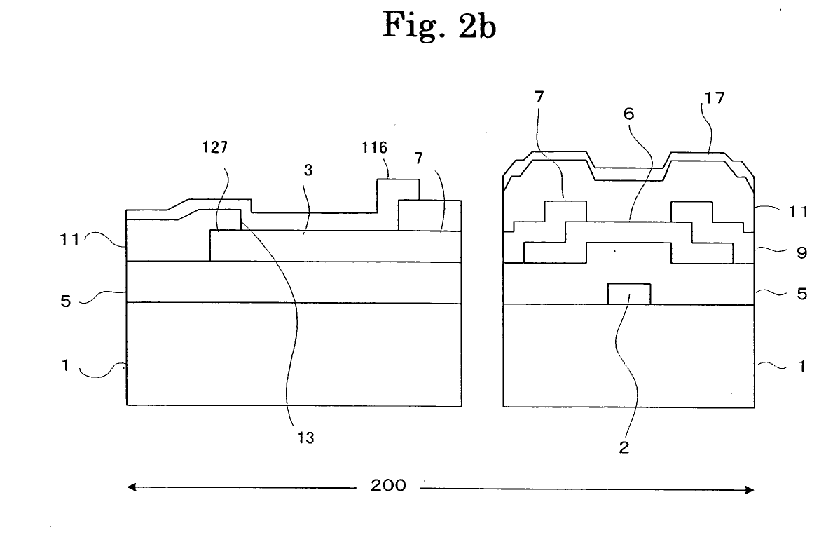

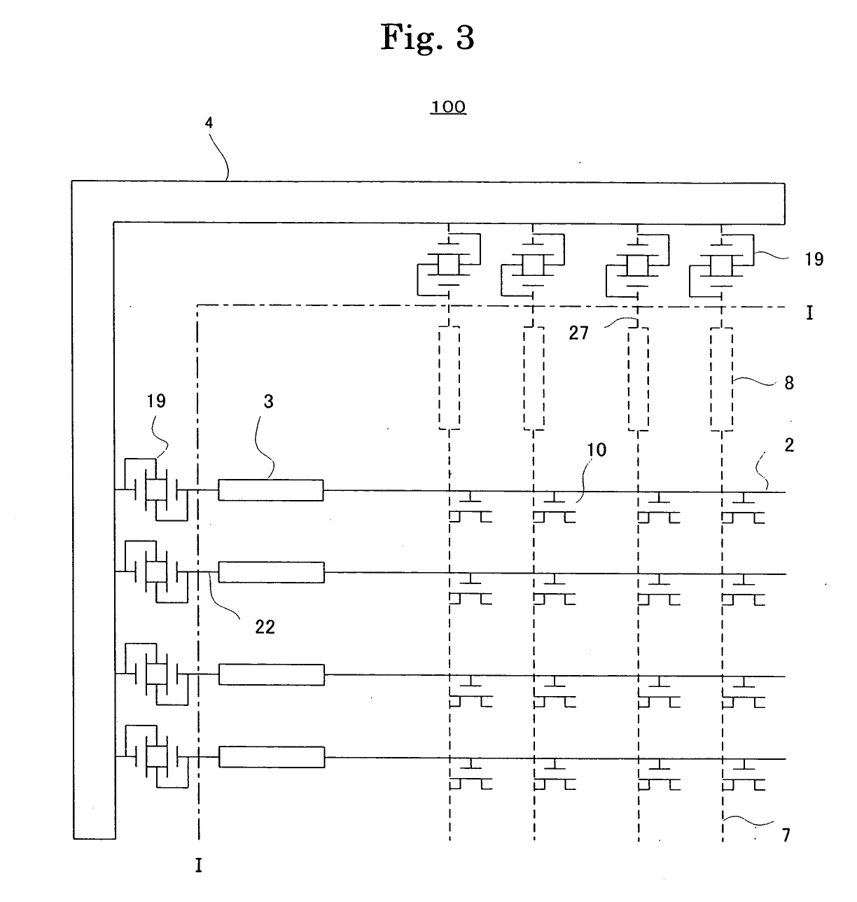

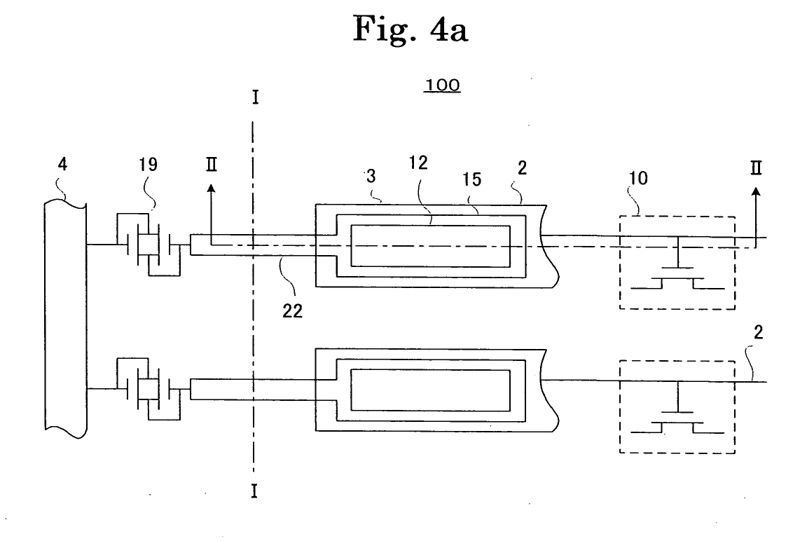

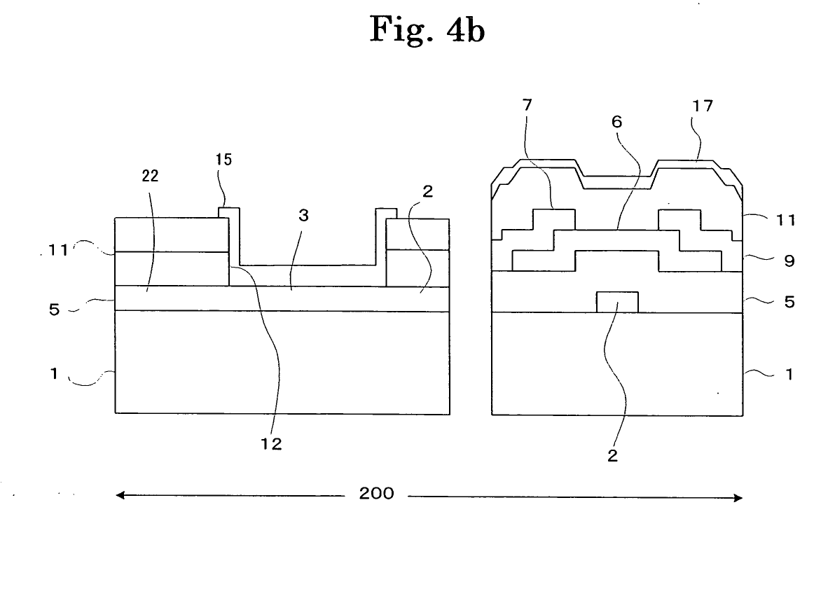

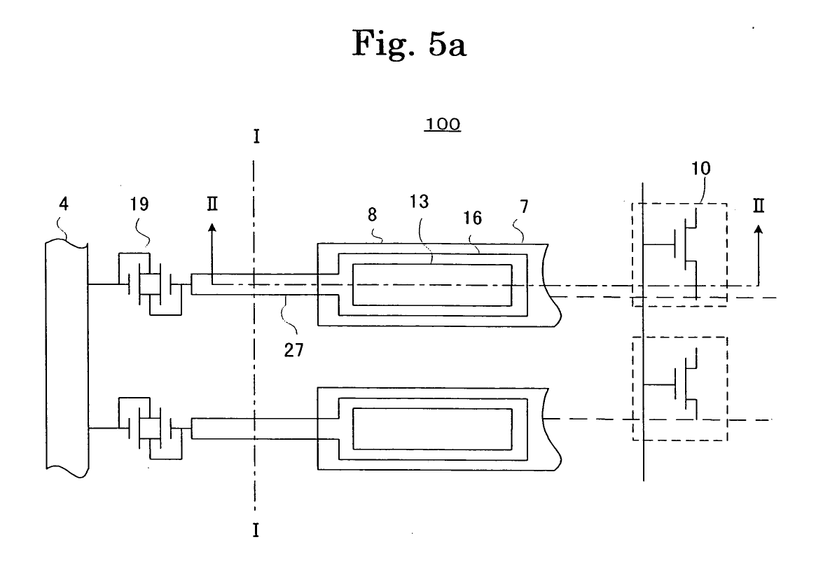

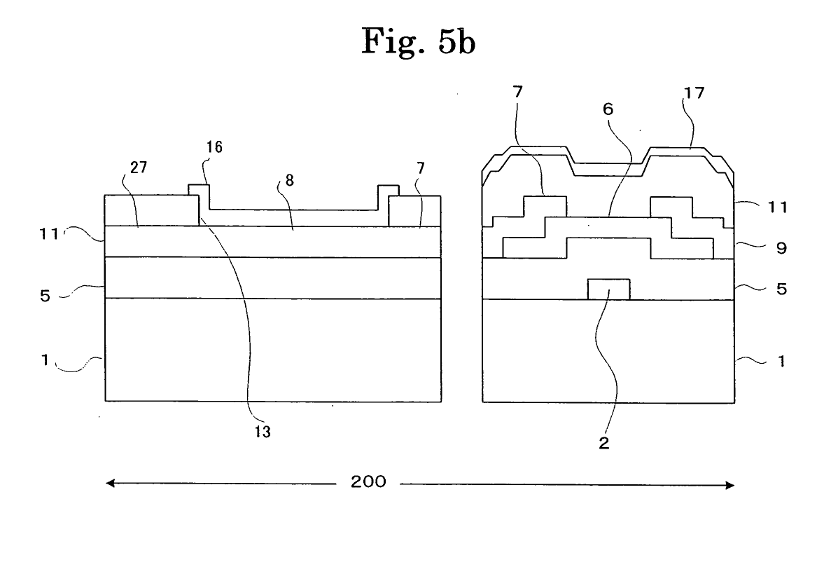

FIG. 1(a) is a plan view in the neighborhood of gate terminals in the embodiment of the thin film transistor substrate according to an embodiment of the present invention. FIG. 1(b) is an enlarged-scale sectional view showing the gate terminal neighborhood after cutting-apart of gate lead lines between the gate terminals and static electricity protection elements. FIGS. 1(b) and 2(b) are sectional views taken along line II-II in FIGS. 1(a) and 2(a), respectively. The circuit structure of the TFT substrate is the same as in the FIG. 3 case, and hence is not described.

In a gate lead line photo resist process, by using a laminate layer of 150 to 300 nm of aluminum and 50 to 200 nm of molybdenum, gate terminals 3 and a static electricity protection lead line 4 which are formed along the edges of eventual TFT substrate 100, are formed together with gate lead lines 2. At this time, the gate lead lines 2 are connected to the gate terminals 3, and gate lead lines 122 extending from the gate terminals 3 cut apart in front of phantom line I-I.

Subsequently, a gate insulating film 5 constituted by a nitride film of 300 to 600 nm is deposited, then a semiconductor layer 6 is formed, and the drain lead lines 7 (including drain electrodes), drain terminals 8 and source electrodes 9 are formed by using a single layer of molybdenum of 50 to 200 nm. In this way, thin film transistors 10 and static electricity protection elements 19 are formed.

The drain lead lines 7 are connected to the drain terminals 8, and the drain lead lines 127 extending from the drain terminals 8, like the gate lead lines 122, are cut apart in front of the line I-I. Subsequently, gate and drain terminal electrodes 115 and 116 are formed together with pixel elements (not shown) constituted by an inter-layer insulating film 11 constituted by a nitride film of 100 to 250 nm, terminal part contact holes 12 and 13 and ITO, and then a polarization film 17 covering the above elements is formed. In this stage, gate and drain terminal electrodes 115 and 116 connect the gate and drain terminals 3 and 8, respectively, to static electricity protection elements 19, and the gate and drain terminals 3 and 8 are connected via the static electricity protection terminals 19 to the static electricity protection lead line 4. In the plan view of FIG. 1(a), each gate terminal electrode 115 is drawn to be found within each gate terminal 3 to cover each contact hole 12 other than a take-out part, but it may be of any shape so long as it covers at least the contact hole 12. This also applies to each drain terminal electrode 116 shown in the plan view of FIG. 2(a).

Finally, the gate and drain terminal electrodes 115 and 116 between the static electricity protection lead line 4 and the gate and drain terminals 3 and 8 are cut apart to separate the static electricity protection lead line 4 and the static electricity protection elements 19 formed along the edges of the eventual TFT substrate 100 from the product TFT substrate 200 having the gate and drain terminals 3 and 8.

In the TFT substrate 200 obtained in this way, on the cutting surface of the TFT substrate 200, the gate and drain terminal electrodes 115 and 116 which are formed from ITO difficulty subject to corrosion progress in atmosphere, are exposed to atmosphere, while the gate and drain lead lines 122 and 127 formed from molybdenum which is readily corroded in atmosphere are protected by the protection film 10 and the inter-layer insulating film 11. Thus, even when the TFT substrate 200 is exposed to atmosphere, it is difficult to proceed the corrosion from the cutting surface, and very high reliability is obtainable.

While in this embodiment use is made of ITO as corrosion-resistant material, it is possible to use IZO (indium zinc oxide). In the case of using a high-melting metal as corrosion-resistant material, such metal may be selected from the group consisting of Cr, Ti, Nb, V, W, Ta, Zr and Hf.

As has been described in the foregoing, with the thin film transistor substrate and the method of manufacturing the same according to the present invention, the corrosion-resistant ITO is cut apart in the vicinity of the gate and drain terminals when separating the display area inside the TFT substrate having the gate and drain terminals from the static electricity protection lead lines and static electricity protection terminals formed along the substrate edges. Thus, no lead line material readily corrodable in atmosphere is exposed to atmosphere, and it is possible to improve the reliability of the gate and drain lead lines.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A thin film transistor substrate comprising a first substrate, gate lead lines provided on the first substrate and having gate terminals formed along the substrate edges, a first insulating film provided on the first substrate such as to cover the gate lead lines, drain lead lines crossing the gate lead lines and having drain terminals formed along the substrate edges, a second insulating film formed on the first insulating film such as to cover the drain lead lines, and gate and drain terminal electrodes covering gate and drain terminal holes, respectively, formed in insulating film on the gate and drain terminals and extending on the outer side of the gate and drain terminals, the gate and drain terminal electrodes being formed by a material having a character of resisting corrosion in atmosphere.

2. The thin film transistor substrate according to claim 1, wherein the gate and drain terminal electrodes are formed by cutting apart, in a state that the gate and drain terminal electrodes extend to the outer side of the gate and drain terminals and are connected to an edge lead line formed along the edges of the first substrate, parts of the gate and drain terminal electrodes extending to the outer side of the gate and drain terminals.

3. The thin film transistor substrate according to claim 1, wherein the material having the character of resisting corrosion in atmosphere is a transparent material.

4. The thin film transistor substrate according to claim 3, wherein the transparent material is ITO (indium titanium oxide) or IZO (indium zinc oxide).

5. The thin film transistor substrate according to claim 1, wherein the material having the character of resisting corrosion in atmosphere is a high-melting metal.

6. The thin film transistor substrate according to claim 5, wherein the high-melting metal is selected from the group consisting of Cr, Ti, Nb, V, W, Ta, Zr or Hf.

7. A method of manufacturing a thin film transistor substrate comprising:
a gate lead line forming step of forming gate lead lines having gate terminals along the edges of a first substrate;
a first insulating film forming step of forming a first insulating film on the first substrate such as to cover the gate lead lines;
a drain lead line forming step of forming, on the first insulating film, drain lead lines crossing the gate lead lines and having drain terminals formed along the substrate edges;
a second insulating film forming step of forming a second insulating film on the first insulating film such as to cover the drain lead lines;
a terminal hole forming step of forming gate and drain terminal holes in insulating film parts on the gate and drain terminals; and
a terminal electrode forming step of forming gate and drain terminal electrodes covering the gate and drain terminal holes and extending to the outer side of the gate and drain terminals;
the gate and drain terminal electrodes being formed from a material having a character of resisting corrosion in atmosphere.

8. A method of manufacturing a thin film transistor substrate according to claim 7, wherein an edge lead line is formed on the first substrate along the edges thereof in the gate or drain gate lead line forming step, edge lead line holes are formed on insulating film on the edge lead line in the terminal hole forming step, in the terminal electrode forming step the gate and drain terminal electrodes are formed such as to extend to the outer side of the gate and drain terminals and past the edge lead line holes so as to be connected to the edge lead line, and the terminal electrode forming step is followed by a terminal electrode cut-apart step of cutting apart parts of the gate and drain terminal electrodes extending to the outer side of the gate and drain terminals.

9. The thin film transistor substrate according to claim 7, wherein the material having the character of resisting corrosion in atmosphere is a transparent material.

10. The thin film transistor substrate according to claim 9, wherein the transparent material is ITO (indium titanium oxide) or IZO (indium zinc oxide).

11. The thin film transistor substrate according to claim 7, wherein the material having the character of resisting corrosion in atmosphere is a high-melting metal.

12. The thin film transistor substrate according to claim 11, wherein the high-melting metal is selected from the group consisting of Cr, Ti, Nb, V, W, Ta, Zr or Hf.
